(19) United States
(12) Patent Application Publication
(10) Pub. No.: US 2010/0276626 A1
(43) Pub. Date: Nov. 4, 2010

(54) Coating Compound for Automobile Construction

(75) Inventors: Joachim Seitzer, Scherzingen (CH); Max Lauchenauer, Horn (CH); Heinrich Sommer, Gonten (CH)

Correspondence Address: SHOEMAKER AND MATTARE, LTD, 10 POST OFFICE ROAD - SUITE 100, SILVER SPRING, MD, 20910, US

(73) Assignee: EFTEC EUROPE HOLDING AG, Zug (CH)

(21) Appl. No.: 12/743,527

(22) PCT Filed: Nov. 18, 2008
(86) PCT No.: PCT/EP2008/065759

§ 371 Date: May 18, 2010

(30) Foreign Application Priority Data
Nov. 23, 2007 (EP) 07121436.5

(51) Int. Cl. E04B 1/74; C04B 14/04; C09C 1/02; C08K 5/00; C08L 33/06; C08L 63/00

(52) U.S. Cl. 252/62; 106/400; 106/483; 106/482; 106/470; 106/499; 524/560; 523/400

(57) ABSTRACT

The invention relates to a coating compound for automobile construction, comprising a filler, preferably an aluminum silicate-based filler, which reduces, more particularly prevents, bubbling on transition from the wet state to the dry state.

The present invention relates to coating compounds for automobile construction that are suitable for attenuating sound and vibration.

In order to attenuate sound and vibrations, more particularly ambient, rolling, and engine noises and vibrations, it is now increasingly common practice to use sprayable compositions which can be applied to the bodywork through robot deployment. In comparison to precut and/or preshaped insulating mats, sprayable compositions produce a considerable labor and cost saving and also an increased flexibility in application.

The sprayable compositions comprise a volatile component; the systems in question are preferably aqueous dispersions from which the water evaporates following application. Evaporation of the volatile component of such compounds is typically completed in the present automotive industry in the tunnel ovens for the baking of the paint. Tunnel ovens of this kind are operated in general at a temperature of about 100° C. to about 180° C.; when the bodywork enters the oven, the surface heats up by at least >10° C./min, typically by about 30° C./min. A major problem associated with this is the formation of bubbles in the coating compositions as a result of the rapid, uncontrolled emergence of the volatile component (also called “bake effect”). The bubbles that are formed burst at the surface and result in an irregular surface structure—in extreme cases, in an interrupted application pattern or in cracks in the acoustic coating.

Known coating compounds, furthermore, exhibit an expansion in coating thickness in the region of about 50% to about 150% in the course of drying. Such an increase in thickness on the part of the coating is often intolerable, as for example when coating compounds are applied in the interior beneath trims or carpets, where the room available for the coating compound is severely limited. Whereas the drying of water-based coating compounds at room temperature or in a slightly elevated temperature range is observed to be accompanied by volume contraction through loss of the water fraction, the drying of the known coating compounds in the temperature range >100° C. is accompanied by expansion, as a result of transition of water into the gaseous state, and, consequently, by inflation or foaming of the compounds.

Document US 2005/0137291 A1 describes coating compounds featuring enhanced rust resistance and appearance, and containing particular fillers.

Document WO 2005/061608 A1 describes coatings featuring low gas permeability and relatively high flexibility.

It is therefore an object of the present invention to avoid the disadvantages of the known art, and hence more particularly to provide a coating compound for attenuating sound and vibration in automobile construction that reduces or prevents the bake effect and also, in particular, exhibits minimal increase in thickness on drying.

This object is achieved by means of a coating compound, a process for preparing such a coating compound, and a method of attenuating the transmission of sound, using such a coating compound, in accordance with the features of the independent claims.

The coating compound for automobile construction in accordance with the invention has a gas loading in the wet state of about 5% to about 60% by volume, preferably of about 10% to about 50% by volume, more preferably of about 15% to about 40% by volume.

A gas loading of this kind may take place, preferably, with ambient air, as for example by mechanical incorporation of air by mixing in commercial mixers. The gas loading is present more particularly in the form of finely divided bubbles. The gas loading is easy to calculate by a determination of density in accordance with DIN EN ISO 2811. If the density of the composition is known, then the volume, and hence the fraction of air in the coating compound, can be calculated by the equation V₁=m₁/ρ₁. In this equation
V₁=volume (without gas loading);
m₁=mass of V₁ (without gas loading);
ρ₁=specific density of the composition (without gas loading).

If a gas, more particularly air, is then incorporated into the coating compound, the composition increases in volume to (V₂). This growth in volume (V₂−V₁) is used to calculate the percentage gas loading.

The gas loading in the context of the invention derives preferably from mechanical incorporation of gas, more particularly air, by mixing, and not, for example, from the presence of a physical or chemical expansion means. With such expansion means it is almost impossible to adjust the increase in film thickness, and that increase, particularly in the case of drying in tunnel ovens, is considerable, in any case greater than 50%.

With further advantage, the coating compound comprises a filler, preferably an aluminum silicate-based filler, which reduces the increase in film thickness on transition from the wet state to the dry state.

By the “wet state” is meant in the present context that state of the coating compound in which it is applied, i.e., prior to the evaporation of the carrier medium, in other words of the solvent or, more particularly, of the dispersion medium, typically of the water.

The “dry state” in the present context is that state of the coating compound in which the residual moisture content (solvent or dispersion medium) is <2% by weight, preferably <1% by weight.

By an “aluminum silicate-based filler” is meant in the present context a filler of the kind that contains more than 50%, preferably more than 60%, more preferably more than 70% by weight of true aluminum silicates, i.e., compounds with different fractions of Al₂O₃ and SiO₂, in which Si is always surrounded tetrahedrally by 4 oxygen atoms, while Al is in octahedral coordination.

In addition to the true aluminum silicates there may also be further Al/Si compounds present in which Al—in contrast to the true aluminum silicates—also occupies Si lattice positions (known as aluminosilicates or alumosilicates, such as, for example, zeolites, feldspars, phyllosilicates, and ionosilicates (see below)), and/or else trimorphic aluminum silicates (such as, for example, andalusite, lillimanite and cynaite) and/or mullite (see below).

The compositions in accordance with the present invention also meet the customary requirements of processing materials in automobile construction, as described, for example, in “Paint and Surface Coatings”, 1987, chapters 10 and 11 (editor: R. Lambourne; Press: Ellis Horwood; ISBN-10: 0853126925); these requirements are incorporated by reference into the present disclosure. Compositions according to the invention therefore exhibit, in particular, the following: (1.) A sufficiently great elasticity to prevent delamination in instances of torsion of the bodywork or of exposure of material to temperatures below the freezing point; (2.) Low emission levels during processing and during the lifetime of the vehicles. Further requirements relate to the following: (3.) Resistance to mechanical loads, such as pressure loading through vehicle occupants, especially at high temperatures in conjunction with high atmospheric humidity; and (4.) Processability in respect of fully automated application, such as pressure resistance in pipelines, pumpability, and sprayability, for example.

Surprisingly it has been found that through the appropriate choice of gas loading, as described above, it is possible to eliminate the bake effect, particularly at a heating rate of about >10° C./min, more particularly by about 30° C./min, from room temperature to about 180° C. As a result of the additional presence of the aforementioned fillers it is also possible in particular to achieve a drastic reduction in the increase in film thickness, typically below 50%.

In addition it has been found, surprisingly, that bubble-free and crack-free baking can be assured at any time, even after the application of the coating and its resting for several hours or several days. This so-called “holding time” or else “open time” prior to baking ensures operational reliability of the composition of the invention in production-line operation. In the case of noninventive products, in contrast, a film is formed at the surface after a certain time. There is then a risk of bubbling and cracking as a result of enclosed water evaporating. In the practical course of automobile production, it is often not possible to comply exactly with standing times, since production interruptions as a result of belt standstill may occur at any time.

In particularly preferred embodiments, the aluminum silicate-based filler has an average particle size (defined as average particle size (d50), corresponding to the particle diameter associated with a sieve undersize of 50%, and calculable or able to be read off from the particle size distribution) of more than about 4 μm, preferably in the range from about 1 μm to about 10 μm, more preferably in the range from about 4 μm to about 10 μm; in this context, the filler is substantially spherical.

In accordance with a further preferred embodiment, the aluminum silicate-based filler, in addition to about 55% to about 90%, preferably about 60% to about 85%, more preferably about 65% to about 80% by weight of true aluminum silicate, further contains about 10% to about 35%, preferably about 12.5% to about 32.5%, more preferably about 15% to about 30% by weight of mullite (Al₄₊₂ₓSi₂₋₂ₓO₁₀₋ₓ); the mullite in this case preferably has a composition of 3Al₂O₃*2SiO₂ to 2 Al₂O₃*SiO₂.

The aluminum silicate-based filler is preferably a synthetic, solid, spherical, melted, vitreous aluminum silicate obtained as flyash in the combustion of coal; with particular preference, the constituents of this filler are inseparable. One filler which is particularly preferred at present in the context of the present invention, and meets the above requirements, is OMEGA-SIL (Omega Minerals, DE-22848 Norderstedt), an iron aluminum silicate having an Fe₂O₃ fraction of about 2.9%.

Fillers which have been found to be particularly suitable and/or—if the above requirements for the filler are not immediately complied with—to be a basis for such a filler include flyashes of the kind used, for example, as an admixture in concrete production (cf. DE 120 36 58, DE 28 01 687, DE 27 58 820, DE 15 71 375). Flyashes are fine, incombustible constituents of a fuel that are entrained by the smoke gases in a firing operation. Flyash, according to DIN EN 450, is a finely particulate dust composed primarily of spherical, vitreous particles, is obtained in the combustion of finely ground coal, has puzzolanic properties, and consists essentially of SiO₂ and Al₂O₃. The amount of effective SiO₂ (that is, free SiO₂ not incorporated into silicate crystals) as specified and determined in accordance with EN 197-1:2000 is at least 25% mass fraction.

With further advantage, the coating compound of the invention contains the aluminum silicate-based filler in a fraction of about 5% to about 35%, preferably of about 10% to about 30%, more preferably of about 20% by weight.

The coating compound of the invention may further comprise a further, acicular and/or fibrous, filler. This is preferably an inosilicate, more particularly selected from Strunz class VIII/F.18 and/or Dana class 65.2.1, preferably a wollastonite. Without wishing to restrict the subject matter of the invention, a filler of this kind appears to produce a capillary effect which channels the evaporation of the water from the coating compound and further supports the prevention of the above-described bake effect.

The wollastonite used preferably at present is KEMOLIT or HYCON from Heinrich Osthoff-Petrasch GmbH, D-Norderstedt, type S3 (aspect ratio 1:10 to 1:15) with 0% sieve residue at 63 μm sieve mesh size by ISO 3310/1 sieve analysis.

The further, acicular and/or fibrous, filler, more particularly the wollastonite, is present here preferably in a fraction of about 5% to about 25%, more preferably of about 10% to about 20%, with particular preference of about 15% by weight in the coating compound of the invention.

The coating compound of the invention may advantageously further comprise an organic solvent in a fraction of about 1% to about 10%, preferably of about 2% to about 6%, more preferably of about 3% by weight, the solvent having a boiling point of, in particular, greater than about 245° C. A solvent of this kind does not evaporate under the usual conditions in the tunnel ovens of the automobile industry, but instead concentrates at the surface. This produces emergence zones for the evaporating water, thereby permitting further suppression of the above-described bake effect, i.e., the raising of bubbles. Suitable solvents are described in, for example, U.S. Pat. No. 6,340,519 B1 and JP 02-281081 A, the description of which in this context is incorporated by reference into the present disclosure.

The coating compound of the invention further preferably comprises a binder based on an aqueous poly(meth)acrylate dispersion, preferably in an amount such as to result in a poly(meth)acrylate fraction in the coating compound, following evaporation of the water, of about 10% to about 20%, preferably of about 12.5% to about 17.5%, more preferably of about 15% by weight. Suitable poly(meth)acrylate dispersions are sufficiently well known in the prior art for use in generic coating compounds, as for example from DE 601 09 152 T2; EP 1 282 672 B1; U.S. Pat. No. 6,686,033 B1; U.S. Pat. No. 4,739,019; “Dispersionen and Emulsionen” 1997, chapter (authors: G. Lagaly, O. Schulz, and R. Zimehl; press: Steinkopff-Verlag Darmstadt; ISBN-10: 3798510873); “Paint and Surface Coatings” 1987 (editor: R. Lambourne; press: Ellis Horwood; ISBN-10: 0853126925); the above literature references, insofar as they relate to suitable poly(meth)acrylate dispersions, are incorporated by reference into the present disclosure.

With particular preference the coating compound in the wet state contains about 15% to about 30%, preferably about 15% to about 25%, more preferably about 18% to about 20% by weight of water. Above a water content of about 30% by weight, there is a perceptible reduction in the capacity for control of the bake effect when the coating compound is used in customary tunnel ovens in the automobile industry; below about 15% by weight, there is a rapid fall in the stability of the dispersion.

With further advantage the coating compound of the invention may comprise a water-retaining filler, more particularly a hydrophobic polysaccharide, preferably a cellulose and/or a starch, as described in JP05331387 and JP05032938. A hydrophobic filler of this kind swells—and thus binds water—at elevated temperature, and so the evaporation of the water is less rapid, and, accordingly, the above-described bubbling can be further controlled.

With further advantage the coating compound of the invention may comprise a powder coating material, preferably an epoxy powder coating material. Suitable powder coating materials are known as such from, for example, EP 509 392 A1, EP 509 393 B1, EP 322 827 B1, EP 517 536 A1, U.S. Pat. No. 4,849,283, U.S. Pat. No. 5,055,524, and also from “Paint and Surface Coatings” 1987 (editor: R. Lambourne; Press: Ellis Horwood; ISBN-10: 0853126925); the description of the above documents, insofar as it relates to suitable powder coating materials, is incorporated by reference into the present disclosure.

It has surprisingly been found that through the addition of an epoxy powder coating material it is possible to achieve a distinct improvement in the condensation resistance of an applied coating compound, more particularly a coating compound of the invention as described above. The condensation resistance here is determined by storage of test specimens for 10 days at 40° C. and 100% relative atmospheric humidity, or, preferably, in the condensation conditions test of DIN 50017.

The coating compound of the invention may of course comprise other customary additives such as, for example, thickeners, rheological additives, dispersants, wetting agents, emulsifiers, dyes, pigments, defoamers, preservatives, plasticizers, antifreeze agents, pH modifier additives, and solvents. Specific compounds from these classes of additive are, in terms of their use, not confined to their typical function, but may instead be used generally in the coating compound of the invention in order to obtain or enhance the desired properties. Specifically, mention may be made of the following:

Pigments, pigment dispersions or dyes for coloring the coating compound of the invention, such as, for example, the commercially available products of the Luconyl series from BASF, e.g., Luconyl Red 3855, products from SIOF, or products of the Akrosperse series from Akrochem. Typically, in each case, in fractions of about 0.1% to about 0.5% by weight.

Organic or mineral rheology modifiers, such as, for example, acrylate thickeners of the Acrysol series from Rohm & Haas, e.g., Acrysol TT-615, or the products of the Rheolate series from Elementis, polyurethane thickeners of the Tafigel series from Munzing, or the products of the DSX series from Cognis, cellulose thickeners of the Tylose series from Clariant, phyllosilicates of the Bentone series from Elementis or from the Laponite series from Rockwood, or silicas of the Cabosil series from Cabot or of the Aerosil series from Degussa. Typically, in each case, in fractions of about 0.3% to about 5.0% by weight.

Plasticizers for flexibilization, such as, for example, adipic acid plasticizers, benzoate plasticizers, sulfonamide plasticizers, phthalate plasticizers, sulfonic ester plasticizers, and phosphate plasticizers. Examples of commercial products include Hexamoll, Unimoll, Ultramoll, and Mesamoll products from Lanxess, e.g., Mesamoll II, or Vestinol products from Degussa. Typically, in each case, in fractions of about 0.2% to about 5% by weight.

Dispersing assistants and wetting agents for dispersing and wetting of the fillers, dispersions, and additives, and so on. Useful dispersing assistants include, for example, polyacrylic acids, organic and inorganic phosphates, polyurethanes, fatty acid esters, and ethylene oxide-propylene oxide copolymers. Commercial products include Metolat 514 from Munzing, and Ultradispers from BASF. Typically, in each case, in fractions of about 0.2% to about 3% by weight.

Fillers which significantly increase the weight per unit area, such as, for example, BaSO₄, micaceous iron or magnetite, typically in a fraction of about 5% to about 40% by weight.

Inorganic or organic fillers such as, for example, calcium carbonate, kaolin, silicates, flyash, glass, talc, mica, titanium dioxide, magnesium carbonate, aluminum hydroxide, slate, carbon black, graphite, iron oxide, silicon dioxide, kieselguhr, micronized polyamide, polyvinyl acetate, poly(meth)acrylates, polyesters, polyethylene or polypropylene. The aforementioned fillers in particular may easily be selected as part of routine tests, and/or incorporated into the coating compound in an amount, such that, on areal application in the wet state in a film thickness of about 3 mm and conversion to the dry state by heating at about 160° C., the film thickness increases only by less than 60%, preferably by less than 50%, more preferably by less than 40%.

A further aspect of the present invention relates, accordingly, to a process for preparing a coating compound for automobile construction, comprising the addition of a gas loading in the wet state of about 5% to about 60%, preferably of about 10% to about 50%, more preferably of about 15% to about 40% by volume; and/or of an aluminum silicate-based filler; and/or of an inosilicate, more particularly selected from Strunz class VIII/F.18 and/or Dana class 65.2.1; and/or of an epoxy powder coating material.

In a further aspect the invention relates to a method of attenuating the transmission of sound in automobile construction, comprising the application of an above-described coating compound to the bodywork or to another component for installation in or on a vehicle.

The invention relates additionally to the use of a gas loading in the wet state of about 5% to about 60%, preferably of about 10% to about 50%, more preferably of about 15% to about 40% by volume; and/or of an aluminum silicate-based filler; and/or of an inosilicate, more particularly selected from Strunz class VIII/F.18 and/or Dana class 65.2.1, as an adjuvant in a coating compound for automobile construction, for the purpose of reducing, more particularly preventing, bubbling on transition from the wet state to the dry state of the coating compound, at a heating rate from room temperature to about 180° C. of about >10° C./min, more particularly by about 30° C./min.

A further aspect of the present invention relates to a substrate, more particularly a vehicle body or parts thereof, coated at least partly with a coating compound as described above.

The invention is illustrated below by a working example, without the subject matter of the invention being restricted to this example. In the figures:

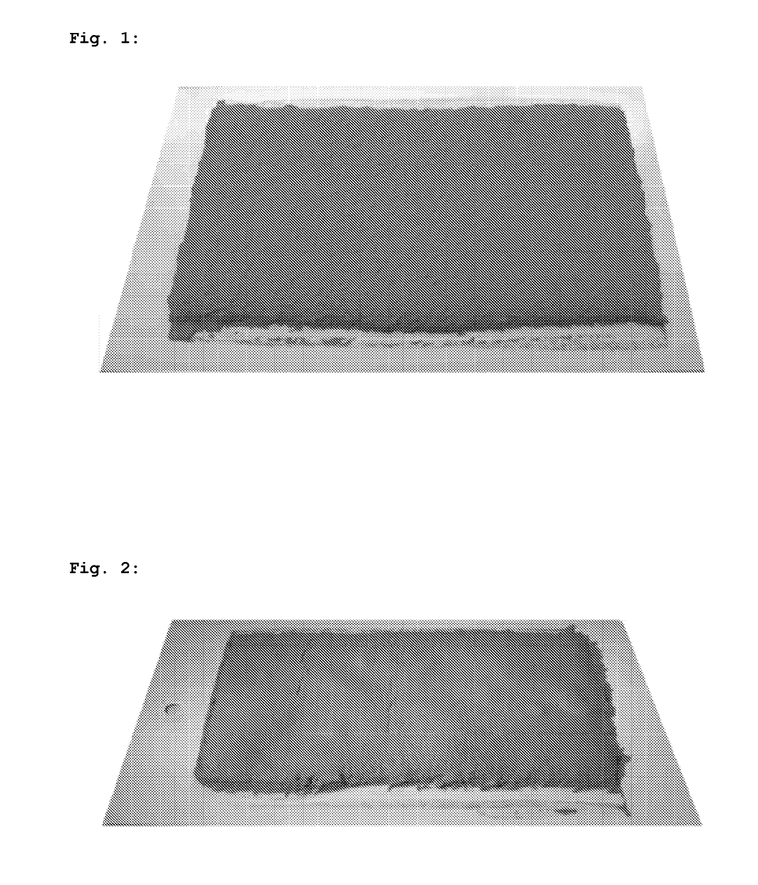

FIG. 1 shows areally applied coating compound with air loading (example A) after drying under tunnel oven conditions;

FIG. 2 shows areally applied coating compound without air loading (example A) after drying under tunnel oven conditions;

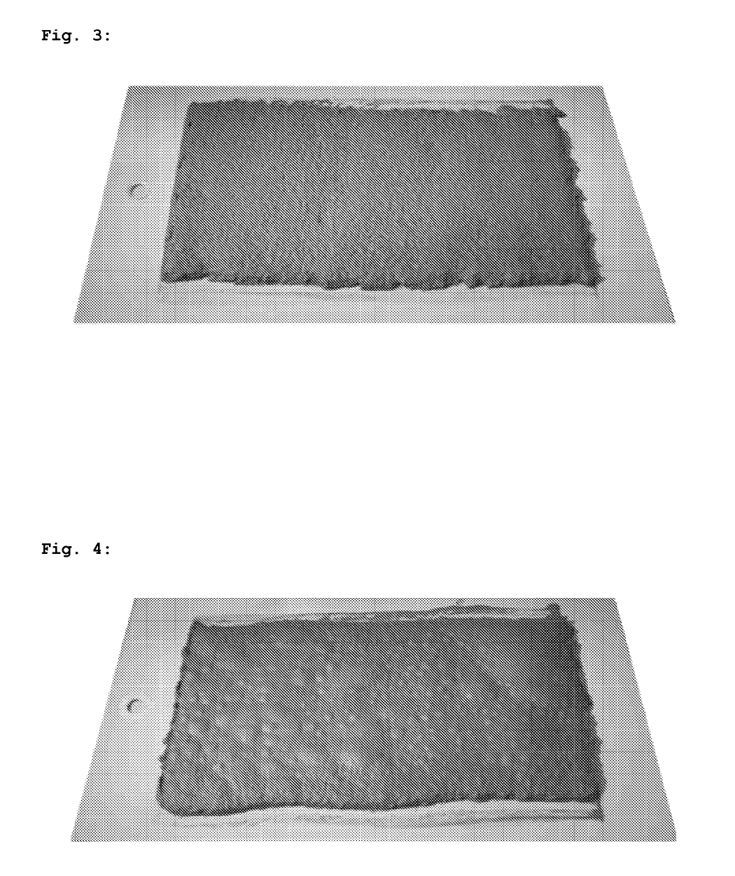

FIG. 3 shows areally applied coating compound with air loading (example B) after drying under tunnel oven conditions;

FIG. 4 shows areally applied coating compound without air loading (example B) after drying under tunnel oven conditions.

The coating compounds prepared were as follows:

TABLE 1
(Formulas)

| # | Raw material | Example A | Example B |
|---|---|---|---|
| 1 | Albucril AC 847 | 12.00 | 12.00 |
| 2 | Mowilith LDM 6119 | 10.00 | 10.00 |
| 3 | Water | 6.00 | 6.00 |
| 4 | Luconyl G Black 0066 | 0.20 | 0.20 |
| 5 | Diethylene glycol | 3.45 | 3.45 |
| 6 | Deuteron ND 953 | 1.00 | 1.00 |
| 7 | Hycon S3 | 15.00 | 15.00 |
| 8 | Barium sulfate | 23.00 | 23.00 |
| 9 | Omega SIL M | 0 | 20.00 |
| 10 | Chalk | 20.00 | 0 |
| 11 | Epoxy powder coating | 5.00 | 5.00 |
| 12 | Starch | 3.00 | 3.00 |
| 13 | Water | 0.65 | 1.00 |
| 14 | Acrysol TT-615 | 0.50 | 0.15 |
| 15 | Hydropalat 875 | 0.20 | 0.20 |

All figures in % by weight
Manufacturer index:
Albucril AC 847 Noveon
Mowilith LDM 6119 Celanese
Luconyl G Black 0066 BASF
Diethylene glycol Fluka
Deuteron ND 953 Deuteron
Hycon S3 Osthoff & Petrasch
Barium sulfate Sachtleben
Omega SIL M Omega Minerals
Chalk Omya
Epoxy powder coating Rohm & Haas
Starch Emsland Stärke
Acrysol TT-615 Rohm & Haas
Hydropalat 875 Cognis

The differences in items #13 and #14 are explained by the difference in rheological behavior between the chalk in example A and the flyash in example B. In order to obtain a comparable viscosity for examples A and B, it is necessary to reduce the amount of the thickener (#14) in example B. This leaves the claimed properties of the coating compound of the invention unaffected.

Preparation took place in accordance with the following protocol: the dispersion components #1 and #2 are introduced into a vessel and mixed with a commercial dissolver at low speed. Then the additives #3 to #6 are added and mixed in. Thereafter the filler components #7 to #12 are added and dispersed homogeneously. Subsequently the additives #13 to #15 are added and mixed in. When all of the constituents of the formula have been added, air is incorporated by mixing with a dissolver until the desired air loading is obtained. The air loading is determined via the known density of the composition and the volume (see above).

In FIG. 1, the coating compound of example A, with an air loading of 40%, has been applied in a thickness of about 3 mm to a metal sheet. This was followed by drying in a tunnel oven, consisting of a PVC pre-gelling oven, simulated by heating of the coated metal sheet from room temperature, at a heating rate of about 30° C./min, to a temperature of about 160° C. Subsequently the surface structure was examined visually. In FIG. 1 there is no perceptible bubbling; the bake effect has been eliminated. However, the increase in the thickness of the coating on drying is still 57%.

In FIG. 2, the identical experimental setup was run with the composition of example A, but the coating compound, prior to application, was evacuated at 100 mbar for 5 min and then had an air loading of 0%. Subsequently, the surface structure was examined visually. In FIG. 2 the above-described bake effect is clearly apparent through cracks, lifting, and bubbles.

In FIG. 3 the identical experimental setup was run with the inventive composition of example B, with an air loading of 40%: in FIG. 3 there is no perceptible bubbling at all; the bake effect has been eliminated. Moreover, it was possible to achieve a drastic reduction in the increase in thickness of the coating on drying, in this case to only 30%. It is found that, in particular, the combination of appropriate air loading and a bubbling-reducing filler results in particularly advantageous outcomes.

In FIG. 4, the identical experimental setup was run with the inventive composition of example B, but the coating compound, prior to application, was evacuated at 100 mbar for 5 min and then had an air loading of 0%. Subsequently, the surface structure was examined visually. In FIG. 4 the above-described bake effect is clearly apparent through lifting and bubbles.

TABLE 2
(Outcomes)

| | | Film | Film | |
|---|---|---|---|---|
| | Air loading | thickness | thickness | Visual |
| | [%] | dry [mm] | Δ [%] | assessment |
| Example A | 40 | 4.7 | 57 | OK |
| (FIG. 1) | | | | |
| Example A | 0 | n.d. | n.d. | bubbles, |
| (FIG. 2) | | | | cracks |
| Example B | 40 | 3.9 | 30 | OK |
| (FIG. 3) | | | | |
| Example B | 0 | n.d | n.d. | bubbles |
| (FIG. 4) | | | | |

n.d., not determined (on account of bubbling)

In summary it may be stated that the inventive coating compound with air loading prevents the described bake effect (bubbling), and, in particular as a result of the inclusion of a bubbling-reducing filler (especially flyash), the increase in film thickness can be drastically reduced.

1-21. (canceled)

22. A coating compound for automobile construction, having a gas loading in the wet state of about 5% to about 60% by volume.

23. The coating compound of claim 22, comprising a filler which reduces the increase in film thickness on transition from the wet state to the dry state.

24. The coating compound of claim 22, with an aluminum silicate-based filler having an average particle size of more than about 4 μm.

25. The coating compound of claim 24, wherein the aluminum silicate-based filler, in addition to about 55% to about 90% by weight of true aluminum silicate, additionally contains about 10% to about 35% by weight of mullite.

26. The coating compound of claim 23, wherein the aluminum silicate-based filler is a synthetic, solid, spherical, melted, vitreous aluminum silicate.

27. The coating compound of claim 23, containing the aluminum silicate-based filler in a fraction of about 5% to about 35% by weight.

28. The coating compound of claim 22, further comprising an acicular filler.

29. The coating compound of claim 22, further comprising a fibrous filler.

30. The coating compound of claim 28, wherein the further filler is an inosilicate.

31. The coating compound of claim 28, wherein the filler is a wollastonite having an aspect ratio of 1:10 to 1:15 and also 0% sieve residue at 250 μm mesh size on sieve analysis in accordance with ISO 3310/1.

32. The coating compound of claim 28, wherein the further filler in a fraction of about 5% to about 25% by weight.

33. The coating compound of claim 22, further comprising in the wet state an organic solvent in a fraction of about 1% to about 10% by weight, the solvent having a boiling point of greater than about 245° C.

34. The coating compound of claim 22, further comprising a binder based on an aqueous poly(meth)acrylate dispersion.

35. The coating compound of claim 22, wherein in the wet state it contains about 15% to about 30% by weight of water.

36. The coating compound of claim 22, further comprising a water-retaining filler.

37. The coating compound of claim 22, comprising an epoxy powder coating material.

38. The coating compound of claim 22, comprising at least one further adjuvant selected from the group encompassing thickeners, rheological additives, dispersants, wetting agents, emulsifiers, pigments, defoamers, preservatives, plasticizers, antifreeze agents, pH modifier additives, and solvents.

39. The coating compound claim 22, wherein the filler(s) is/are selected such that, when applied areally in the wet state in a film thickness of about 3 mm and converted to the dry state by heating at about 160° C., the film thickness increases only by less than 60%.

40. The coating compound claim 22, wherein the filler(s) is/are present in an amount such that, when applied areally in the wet state in a film thickness of about 3 mm and converted to the dry state by heating at about 160° C., the film thickness increases only by less than 60%.

41. A process for preparing a coating compound for automobile construction, comprising the step of adding a gas loading, not based on a physical or chemical expansion means, of about 5% to about 60% by volume in the wet state.

42. A method of attenuating the transmission of sound in automobile construction, comprising the step of applying a coating compound of claim 22.
